(19) United States
(12) Patent Application Publication
(10) Pub. No.: US 2026/0025886 A1
(43) Pub. Date: Jan. 22, 2026

(54) Two Parameter Control for RF Warming of Cryopreserved Tissue Samples

(71) Applicant: TDA Research, Inc., Golden, CO (US)

(72) Inventors: David P. Eisenberg, Denver, CO (US); John Michael Alford, Lakewood, CO (US); Joshua Wewerka, Wheat Ridge, CO (US)

(21) Appl. No.: 19/277,091

(22) Filed: Jul. 22, 2025

Related U.S. Application Data
(60) Provisional application No. 63/674,245, filed on Jul. 22, 2024.

(51) Int. Cl. H05B 6/80; H05B 6/68; H05B 6/72

(52) U.S. Cl. CPC H05B 6/806; H05B 6/688; H05B 6/725

(57) ABSTRACT

A method for RF rewarming of cryopreserved tissues, organs, cartilage, arteries, and the like, whereby the samples are uniformly, volumetrically rewarmed to promote viability. The method maintains a warming rate above the critical warming rate of a CPA, preferably DP6 or VS55, during the critical warming period (−80° C. to −30° C.) and does not produce cracks, crystallization, or destructive thermal gradients during devitrification. The method also minimizes CPA toxicity. The method controls frequency and impedance matching to keep the system at resonant frequency and an input impedance of 50 Ω.

### RELATED APPLICATIONS

The present application claims the benefit of provisional application No. 63/674,245 filed Jul. 22, 2024 (titled Two Parameter Control for RF Warming of Cryopreserved Tissue Samples, by David P. Eisenberg, John M. Alford, Joshua Wewerka), which is incorporated by reference herein.

### STATEMENT OF GOVERNMENT INTEREST

This invention was made in part using U.S. government funding under Contract No. W81XWH21C0035 awarded by the Defense Health Agency. The government has certain rights in this invention.

### BACKGROUND

The ability to cryogenically preserve tissues, organs, and limbs and then successfully rewarm them when needed for transplants has been a paramount goal for decades. If achieved, this would have a tremendous impact in surgical and reconstructive medicine. Currently, donor organs stored on ice can only be transported over short periods of time; typical times range from 4-6 hours for hearts and lungs, up to 24-36 hours for kidneys, and 14-28 days for cartilage. In many cases, this is not sufficient to provide adequate tissue matching and shipping to the transplant hospital.

According to DHHS, approximately 20 people die each day waiting for organ transplants and over 113,000 people are currently on the national transplant waiting list. In the armed forces, in many cases, limbs and tissues that are severed in the field could be successfully reattached, but there is currently no way to preserve the tissue for later surgery. Both situations could be greatly helped if there were a viable way to freeze, preserve, and rethaw the organs, limbs, and tissues for use at a later date. Organs could be stored in cryobanks until the best donor is found, and limbs could be preserved for later reattachment at a proper facility.

The main nemesis of cryogenic preservation is the formation of ice crystals that damage tissue and cellular structures during freezing and thawing, and it is generally agreed that this is the single most important factor restricting the extent to which tissues can survive cryopreservation. Vitrification (direct cooling into a glassy or amorphous state) is one of the most promising methods for avoiding ice formation during cryopreservation, however multiple issues arise which have made it unsuccessful for freezing and rethawing larger organs and limbs. For cryopreservation via vitrification to succeed, two critical techniques must be developed: 1) tissues need to be successfully vitrified (perfusion, cooling and storage technologies, and advanced cryoprotecting agents (CPAs) are needed), and 2) there needs to be a technique that can properly rewarm the tissue.

The rewarming process is the most difficult part of the process, because warming rates generally need to be much higher than cooling rates to prevent devitrification and ice crystallization. However, high warming rates can lead to thermal gradients in the tissue, whereby the mechanical stress causes the tissue to fracture. Either crystallization or fracture during rewarming will render the tissue non-viable.

Developments of modern vitrifiable CPAs was a vital step for cryopreservation, since early cryopreservation work was severely hindered by the lack of good CPAs as well as the perfusion techniques to add and remove them. The development of many useful CPA formulations such as VMP and M22 and methods to add and remove them have still not solved the rewarming problem. Fahy's M22 solution is extremely resistant to rewarming phase crystallization, and can be rewarmed at an amazingly slow 1° C./min. However, the method of rewarming with M22 was not 100% successful and worked on only some animals (too unreliable for further use). Ice may have still formed in some areas of the kidney where perfusion was poor, or chilling injury and/or toxicity of the CPA was too severe for 100% survival. High levels of CPA concentrations, which decrease the critical thermal rate (reduce mechanical stress), can be toxic to organs and tissues.

There are three competing interests that all need to be satisfied for successful thawing of cryopreserved tissues: (1) minimize CPA toxicity, (2) prevent ice crystallization (especially during rewarming), and (3) keep thermal mechanical stress within allowable limits (to not cause fracturing). The competing balance between these three goals is illustrated in FIG. 1.

Using a low CPA concentration (to minimize toxicity) requires a very high warming rate to prevent rewarming phase crystallization. Fast warming is not yet possible in the center of bulky tissues due to the low thermal conductivity of biological materials. Even in smaller tissues, overly fast warming rates cause high thermal gradients which lead to excessive thermal mechanical stress, causing fractures that damage the tissue.

Higher concentration CPAs (like M22) are highly toxic. To minimize the effects of toxicity, tissues are perfused at low temperatures (when the metabolism is slower). M22 can only be fully loaded into the tissue at −22° C. Unfortunately, at low temperature the CPA's viscosity is much higher, so it is very hard to properly perfuse the CPA through the tissue's vasculature. Regions of the tissue with insufficient CPA concentration suffer from crystallization, and it's likely that this was the problem with Fahy's M22 experiments.

Early work to study dielectric heating of dog kidneys using microwave ovens (2.45 GHZ) started in the late 1960's with some with some initially promising results reported by Guttman et al. (1977). However, these were later shown to be irreproducible by others at the time, Pegg et al. (1978). To improve uniformity, a different approach using a dielectric loaded waveguide horn at 918 MHz was subsequently developed by Burdette et al. (1980). However, none of these approaches proved successful. From a heating perspective, the wavelengths were too short to allow good penetration depth and uniformity for the size of the kidney (causing hot spots), and the dielectric absorption was not ideal for subzero temperatures and caused thermal runaway at higher temperatures. Additionally, the development of cryoprotective agents was in its infancy and the solutions employed would probably not have worked even if the heating problems had been solved.

Subsequent work measuring the temperature dependent dielectric constants for potential CPAs by Marsland et al. (1987) showed that lower frequencies may yield better results and that as the tissue was permeated with the CPA, its dielectric properties became dominated by that of the CPA. These results then lead to the design and construction of a prototype 434 MHz rewarming system (Evans et al. 1992, Rachman et al. 1992, and Penfold and Evans 1993). Calculations by Bai et al. (1992) and experiments by Penfold and Evans (1993) showed that good uniformity was possible over a region of about 3.6 cm. While the sample size was limited, it was a very sophisticated design and was used for many productive experimental measurements of the effects of CPAs and sample shapes on heating uniformity through 2002 (Robinson et al. 2002). A new apparatus based on this design has recently been built by Lou et al. (2006). The potential ability to use still lower frequencies (27 MHz) was reported by Ruggera and Fahy (1990), but was not followed up. Further development of dielectric heating was probably stalled by the complicated engineering problems encountered with high frequency RF design and perceived problems with heating uniformity and thermal runaway.

Magnetic heating using superparamagnetic iron oxide nanoparticle for rapid rewarming (nanowarming) is a much newer method of internal heating reported in 2017 by Manuchehrabadi et al. Previously, these types of nanoparticles had been employed for MRI contrast enhancement and experiments in cancer hyperthermy. Their use for rewarming vitrified tissues could be a breakthrough as exemplified by the recent vitrification and storage (at −150° C. for 100 days), followed by successful rewarming and transplantation of rat kidneys that regained full renal function (Han et al., 2023). This group is also currently working on nanowarming for liver (Sharma et al., 2023) and heart cryopreservation models (Gao et al., 2022). Nanowarming of cartilage has also been studied (Chen et al., 2023), with mixed results as we will discuss further.

Unfortunately, nanowarming still has some drawbacks. The specific absorption rate or SAR of the magnetic nanoparticles is not very high at the low excitation frequencies employed, so rapid heating requires very high magnetic fields and very high concentrations of nanoparticles, on the order of 1-2 mg/ml (near the solubility limit). This high concentration must be perfused uniformly into the tissue and then removed. Heating uniformity due to the nanoparticle distribution is a concern, but this has been measured by MRI and appears to be adequate for the kidneys employed above. Unfortunately, nanoparticles do not leave the vasculature, and since cartilage does not have any vasculature, all CPA and nanoparticle mass transfer must occur by diffusion from the tissue surface. In the experiments by Chen et al. (2023), the nanoparticles had no penetration into the deeper, boney areas of their osteochondral cartilage. Consequently, their heating was from the outside in and not uniform. Their results near the cartilage surface were dramatically better than conventional water bath heating, but the deep tissue (where the nanoparticles could not diffuse to) showed very poor viability after thawing.

There is a need for a fast-warming, uniform method for cryopreservation that provides viable tissues and organs after vitrification (no crystal formation during cooling or thawing, no fracturing or puncturing). Uniform internal heat generation is required for large samples to maintain integrity. There is presently no known method that can accomplish this for practical (organ or limb) sized samples. The combination of highly uniform heating and high heating rates is unattainable by current methods.

### SUMMARY OF THE INVENTION

The present disclosure provides a method for thawing tissues, organs, arteries, cartilage, skin patches, and the like after cryopreservation. This improved electromagnetic thawing technique involves a heating mechanism that does not rely on diffusion of nanoparticles. The method uses a 2-parameter control for impedance matching with larger wavelengths for more uniform absorption (i.e., warming) by a sample. The method provides quick heating in the critical temperature range (−80 to −30° C.), allows for reduced CPA concentrations, and prevents or significantly reduces rewarming phase crystallization during thawing. The disclosure allows tissues and organs to be heated volumetrically, uniformly, and quickly.

The present method allows for uniform, volumetric rewarming of tissues and organs that have been perfused with CPAs. The method uses ^{˜}40 MHz RF waves and a high electric field to generate heating rates above the critical warming rate (CWR) of the perfused CPA and produces samples with high viability post thawing. The method relies on resonance and impedance matching to uniformly heat, and adjust the heating of, various samples. Using a 2-parameter approach, the input frequency and tunable impedance matching source (antenna, coupler, etc.) are continuously updated to provide uniform heating throughout the sample as was impossible to reproduce in the prior art.

It is a teaching of this disclosure that successful RF rewarming of vitrified tissues, cartilages, organs, and the like require precise impedance matching to accomplish uniform, volumetric heating. To accomplish this, the frequency must be kept at resonant frequency and the impedance must be matched to 50Ω. The 2 parameters (frequency and impedance) are looped continuously at different rates, so each adjustment in frequency is negligible to the adjustments in resistance (impedance), and vice versa. Using the reflected power as a reference measurement for adjustments, the frequency is electronically controlled, while the impedance is mechanically controlled. The electronic frequency loop adjusts the frequency ^{˜}1000 times per second, while the mechanical loading loop adjusts the resistance ^{˜}10 times per second. The control system is summarized in FIG. 3.

The present disclosure provides a method for rewarming vitrified tissues, the steps comprising: a) providing a RF warming apparatus; b) providing a vitrified tissue, wherein the vitrified tissue is perfused with a CPA; c) continuously adjusting an input frequency to maintain a resonant frequency throughout the RF warming apparatus; d) continuously tuning an impedance matching source to maintain a system impedance of 50Ω-75Ω; and, uniformly warming the vitrified tissue at a rate above the critical warming rate for the CPA between −80° C. and −30° C.

In a preferred embodiment of the method, the CPA has a maximum power adsorption below-30° C. at frequencies of 10-100 MHZ. In another embodiment, the input frequency is 10-100 MHZ, more preferably 30-50 MHz.

In an embodiment, continuously adjusting the input frequency comprises: aa) measuring a reflected power; bb) adjusting the input frequency to a higher frequency, then re-measuring the reflected power; cc) adjusting the input frequency to a lower frequency, then re-measuring the reflected power; dd) comparing the reflected power of the higher frequency and the reflected power of the lower frequency to select a new input frequency; and, ee) repeating steps aa)-dd). In an embodiment, continuously adjusting the impedance matching source comprises: aaa) measuring a reflected power; bbb) adjusting the impedance matching source to a new position in a first direction, then re-measuring the reflected power; ccc) adjusting the impedance matching source to a new position in a second direction, then re-measuring the reflected power; ddd) comparing the reflected power of the new position in the first direction and the new position in the second direction to select a new position; and, eee) repeating steps aaa)-ddd).

In an embodiment, the impedance matching source is a coupling antenna or a variable capacitor, though alternate impedance matching sources are possible.

The method may further comprise f) retrieving a thawed tissue, wherein at least 70% of the thawed tissue is viable.

The input frequency may be 40 MHz. The system impedance may be 50Ω. Continuously adjusting the input frequency may further comprise adjusting the input frequency at least 100 times per second, and continuously tuning the impedance matching source may comprise tuning the impedance matching source at least 10 times per second. Preferably, continuously adjusting the input frequency further comprises adjusting the input frequency 500-1000 times per second, and wherein continuously tuning the impedance matching source may comprise tuning the impedance matching source 50-100 times per second.

The CPA may be DP6, DP8, VS55, or VS83, among other similar CPAs.

Preferably, warming the vitrified tissue does not comprise forming crystals, cracks, or thermal gradients in the vitrified tissue.

The present disclosure also provides a method for impedance matching during RF rewarming, the method comprising: a) measuring a frequency, a reflected power, and a reflected voltage; b) adjusting the frequency to maintain a resonant frequency at least 100 times per second, the steps comprising: i) measuring a reflected power; ii) adjusting the input frequency to a higher frequency, then re-measuring the reflected power; iii) adjusting the input frequency to a lower frequency, then re-measuring the reflected power; iv) comparing the reflected power of the higher frequency and the reflected power of the lower frequency to select a new input frequency; and, v) repeating steps i)-iv); and, c) tuning an impedance coupler at least 10 times per second to maintain a system impedance of 50Ω-75Ω, the steps comprising: i) measuring a reflected power; ii) adjusting the impedance matching source to a new position in a first direction, then re-measuring the reflected power; iii) adjusting the impedance matching source to a new position in a second direction, then re-measuring the reflected power; iv) comparing the reflected power of the new position in the first direction and the new position in the second direction to select a new position; and, v) repeating steps i)-iv).

The method may further comprise the step d) reheating a sample without forming any crystals or cracks. The impedance coupler may be a coupling antenna or a variable capacitor. Preferably, the impedance remains matched in the temperature range from −80° C. to −30° C.

### BRIEF DESCRIPTION OF FIGURES

The patent or application file contains at least one drawing executed in color. Copies of this patent or patent application with color drawing(s) will be provided by the Office upon request and payment of the necessary fee.

FIG. 1: Conflicting issues with cryopreservation.

FIG. 2: Full RF warming system with control and matching details.

FIG. 3: RF warming control system flow chart.

FIG. 4: Temperature vs. time for sample of DP6 rewarmed by RF method.

FIG. 5: Heating rate vs. temperature for sample of DP6 rewarmed by RF method.

FIG. 6: Vitrified sample of DP6 at beginning of rewarming by RF method.

FIG. 7: Sample of DP8 in situ a) vitrified without cracks or ice crystals b) successfully rewarmed.

FIG. 8: Delivered power and temperature recorded during DP8 heating test.

FIG. 9: Temperature vs. time for sample of DP8 rewarmed by RF method.

FIG. 10: Delivered power and temperature recorded during VS55 heating test.

FIG. 11: Temperature vs. time for sample of VS55 rewarmed by RF method.

FIG. 12: Sample of VS55 in situ a) vitrified without cracks or ice crystals b) successfully rewarmed.

FIG. 13: Sample of VS85 in situ a) vitrified without cracks or ice crystals b) successfully rewarmed.

FIG. 14: Temperature vs. time for sample of VS85 rewarmed by RF method a) measured by CH1 temperature sensor b) measured by CH2 temperature sensor.

FIG. 15: Temperature vs. time for sample of articular cartilage perfused with DP6 with corresponding pictures in situ.

FIG. 16: Temperature vs time for 10 ml sample of VS55.

FIGS. 17A-C: results of live/dead images and metabolic activity results.

FIG. 17D: statistics and analysis of live/dead fluorescence values.

FIG. 17E: results of the alamarBlue® in three groups over 6 days.

FIG. 17F: cartilage glycosaminoglycan concentration percent in three groups.

FIGS. 18A-H: results of live/dead images and metabolic activity results (before/after) for multiple samples.

FIG. 181: results of the alamarBlue® in four groups over 5 days.

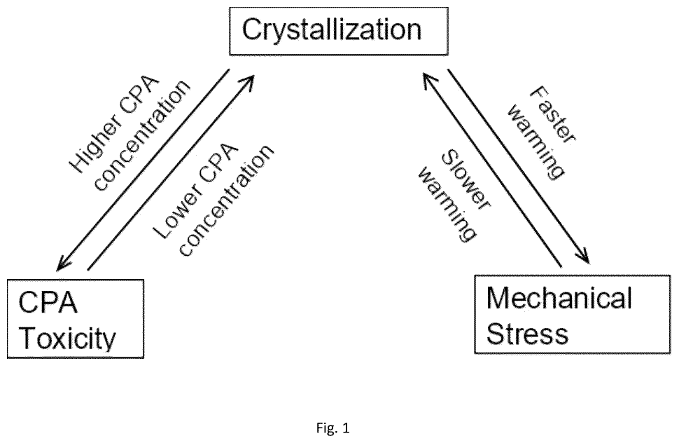

FIG. 19: Rewarming a 10 ml sample of VS55.

FIG. 20: Summary of rewarming results.

FIG. 21: Viability of 10 mL samples after convective or RF rewarming.

### DETAILED DESCRIPTION OF THE INVENTION

Volumetric electromagnetic warming overcomes the three-part tension of minimizing CPA toxicity, preventing ice crystallization, and keeping thermal mechanical stress within allowable limits because it allows for very fast and very uniform heating. This way, low concentration CPAs are used, crystallization is avoided with fast warming, and thermal mechanical stress is kept at a minimum because the heating is more uniform (minimizing thermal gradients). Importantly, the heating rate doesn't need to be perfectly uniform. Even non-uniform volumetric heating leads to much less thermal mechanical stress than convective heating (which heats from the outside in) because it heats from the inside out. Due to the path dependent nature of the thermal mechanical stress in the viscoelastic tissue/CPA medium, heating from the inside out generates stresses that oppose the residual stress caused by cooling instead of building on top of them (as is the case with convective warming). The method described herein works for both vascular and avascular tissues, and provides an approach for volumetric warming of large-scale avascular tissues (cartilage, tendons, ligaments), which is not achievable with other methods in the art. Additionally, the RF warming technology does not require any kind of nanoparticle susceptor and relies on heating the CPA directly—this prevents potential obstacles to long term health and avoids diffusion problems of nanoparticles.

The present method uses 30 MHz-50 MHz radio frequency waves, or preferably ^{˜}40 MHz radio frequency waves. Using low frequency RF waves solves some of the problems of the prior art-longer wavelengths penetrate the samples better, allowing for more uniform heating. The CPA becomes very absorbing at certain temperatures, so the penetration depth for power (depth where the power drops by half) varies greatly for different frequencies. At 40 MHz, half the power is gone by about 20 cm, whereas at 434 MHz half the power is gone in about 2 cm. Generally, a wavelength ^{˜}3× the length of the sample being rewarmed is necessary to avoid a thermal gradient—the exact maximum wavelength (minimum frequency) necessary is dependent on sample size. Additionally, longer wavelengths can prevent standing waves (causing peaks and troughs at half wavelength intervals, varying the electric field and causing cold/hot spots) if they are at least 2× longer than the sample size, preferably larger.

It is a teaching of this disclosure that rapid, uniform heating is required during the critical warming period from −80° C. to −30° C. while rewarming cryopreserved tissues. The CPAs discussed herein have peak absorbency of EM energy around the critical warming period, allowing for a high heating rate during the period when the CPA has the highest ice growth rate. Low frequencies have very good thermal runaway characteristics (they provide stable heating) up to the typical melting point of the CPA (which is the point that rapid heating can be stopped).

A human kidney is about 11 cm±1 cm, so the highest acceptable frequency would be ^{˜}100 MHZ. Larger organs will need still lower frequencies. Thus, a frequency less than 100 MHz is needed for practical organ cryopreservation. Previous methods have proved unsuccessful at either 1) generating enough heat or 2) keeping the impedance matched throughout the critical warming period. The present disclosure teaches a 2-parameter approach to impedance matching for increased control and uniformity while thawing cryogenically preserved tissues or organs during the critical warming period of −80° C. to −30° C. at low frequencies.

An alternating current between parallel plates provides enough energy to generate heat, and the system is kept at a resonant frequency to maximize the electric field. To provide sufficient energy for fast heating with lower frequency RF waves, the electric field between the plates is increased (increasing the charge on the plates increases the electric field between the plates). The polar CPA molecules generate the heat in the alternating electric field, quickly warming the tissue during the critical warming period of −80° C. to −30° C. The electric fields between charged parallel plates are uniform. The system is designed to work at 30 MHz-50 MHz.

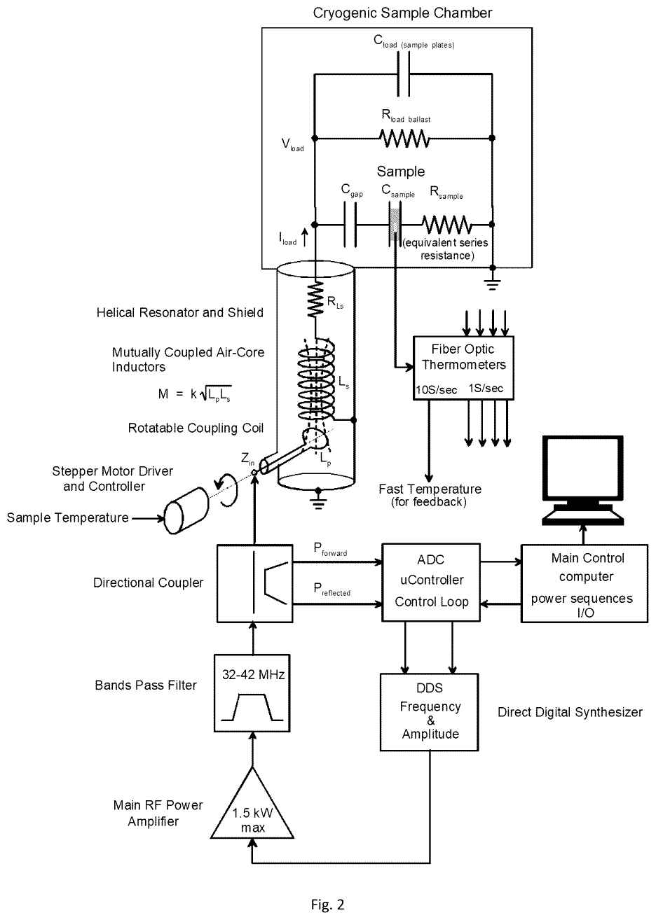

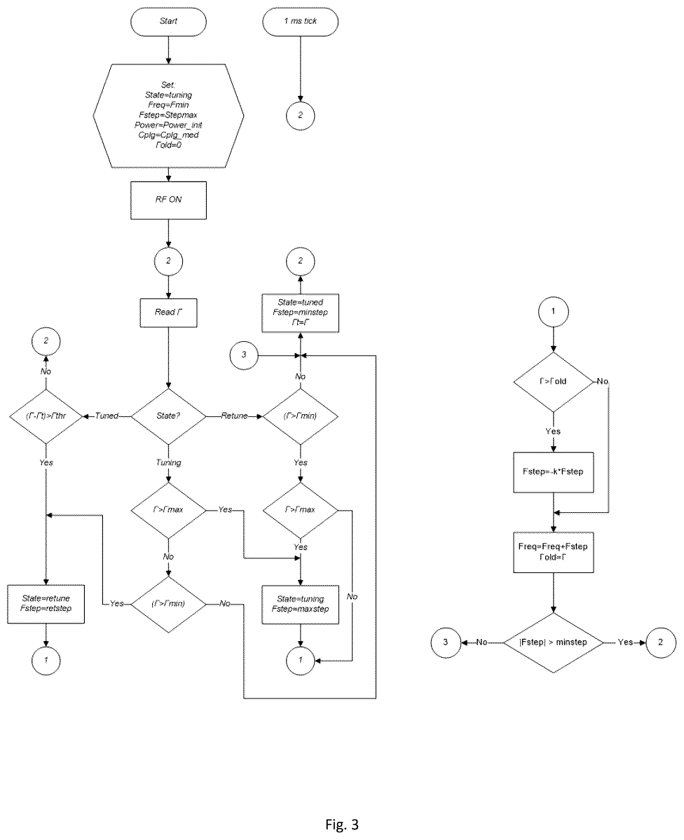

The design, shown in FIG. 2, uses an RF applicator approach by placing the sample between the plates of a capacitor. This allows for in-situ cooling of the sample with LN₂ sprayers before it is quickly slid between the plates of the capacitor for rewarming. It also permits easy access for imaging so that the entire cooling and reheating process can be recorded to look for evidence of crystallization or cracking. As will become important for obtaining better uniformity, this approach also makes it easy to change the shape of the capacitor electrodes (applicator) to generate more uniform heating.

RF power going into the sample is monitored by a directional coupler to determine the forward and reflected power. Ideally, there should be no reflection as this represents lost power that can damage the amplifier. These signals are analyzed to determine their relative phase and amplitude ratio, which are then digitized and sent to a microcontroller-based control loop. As the sample warms, its dielectric properties change, changing both the system's resonance frequency and its impedance. Matching to the sample load is accomplished in two steps: 1) the changing capacitance causes the resonant frequency of the LC circuit to change too rapidly for a mechanical mechanism. To compensate, the resonant frequency is adjusted using a digital frequency synthesizer that can change frequencies up to 1000 times per second; and 2) as the resistance of the rewarming sample changes, a rotatable coupling coil is turned with a stepper motor to adjust the mutual inductance or coupling into the resonant inductor. This loop is slower than the first loop and updates several times per second. The system computes the transmitted RF power and can adjust the signal generator amplitude to provide constant heating power. The applicator electrode voltage is also monitored to prevent arcing. The temperature of the sample is monitored at up to four positions at ten times per second, optionally by using a Rugged Monitoring 4-channel cryogenic optical temperature sensor system.

The control system delivers a controllable amount of RF power to the sample, which presents a variable complex load Z=R+j*X, where both R (real part of impedance, resistance) and X (imaginary part of impedance, reactance) are varying depending on the amount of the delivered RF energy, instantaneous power, temperature, etc. In this case, j represents the imaginary number. In general, the amount of reflected power should be minimized, so that most of the forward power is delivered to the sample. The control system needs to both keep the applied frequency at the system's resonant frequency, and the system's impedance at 50Ω. The applied RF frequency is controlled directly by a signal generator and influences the reactance, while the system's resistance is influenced by the angle of the coupling antenna. Technically, the angle of the coupling antenna changes both R and X, but by keeping the system at resonance, X becomes zero and tuning the angle only affects R. Alternative controls may be used, so long as the two variables (reactance and resistance) are constantly monitored and adjusted with the changing sample. When the frequency is controlled in real time, the imaginary portion of the equation cancels out and the real part of the equation (resistance) is critical for impedance matching. The present disclosure teaches that the 2 parameters must be controlled and adjusted simultaneously to prevent crystallization while rewarming tissues and organs—the specific approach provided is the first successful approach with the 2 parameters in consideration.

In designing the RF system, it is important to consider forward and reflected voltage and power. The basic relationships are as follows:

$${P}_{d} = {P}_{forward} - {P}_{reflected} \qquad ( 1 )$$

$$Γ = \frac{{V}_{r}}{{V}_{f}} \qquad ( 2 )$$

$$\frac{{P}_{r}}{{P}_{f}} = {\vert Γ \vert}^{2} \qquad ( 3 )$$

$${P}_{d} = {P}_{f} * ( 1 - {\vert Γ \vert}^{2} ) \qquad ( 4 )$$

Where V_{f} is forward voltage, P_{f} is forward power, Vᵣ is reflected voltage, Pᵣ is reflected power, V_{d} is delivered voltage, P_{d} is delivered power, and Γ is the complex reflection coefficient. The source impedance and coaxial cable characteristic impedance is 50Ω, so Z₀=50 Ω

In general, there are two control loops for 2 parameters. The first one electronically controls frequency and the second one mechanically controls the impedance matching (because the frequency control cancels out the imaginary part of impedance), adjusting the angle of a coupling antenna to achieve an impedance of 50Ω. To maintain a steady control system, where the two loops are not fighting each other, the frequency loop occurs very fast (on the order of 0.001 s) and the impedance matching loop occurs ^{˜}100× slower (on the order of 0.1 s). This way, from the point of view of the frequency loop, the impedance loop is standing still, and from the point of view of the impedance loop, the frequency loop is acting nearly instantaneously. By adjusting both the frequency and impedance matching at these rates, the present method achieves uniform heating in samples that was previously impossible.

This type of frequency and coupling response allows for a universal and non-complex impedance matching algorithm, which searches for the minimum of |Γ| without any knowledge of the equivalent circuit (black box approach). The present method allows for the impedance and power/frequency control parameters to be sufficiently decoupled.

The control scheme contains two loops, a fast loop adjusts the frequency to maintain resonance while a slow loop adjusts the coupling antenna (or a variable capacitor) to keep the impedance matched at 50Ω. In practice, this will look like:

The frequency is controlled to minimize the “imaginary” part of impedance (X). The mechanical coupler angle is controlled to match the “real” part of impedance (R) to 50Ω. Correspondingly, there are 2 concurrent loops, substantially separated in frequency domain.

The frequency loop measures |Γ| or |Γ|², varying RF frequency with the parameters:
(a) Max (initial) frequency step: 0.2 MHz
(b) Min (tuned) frequency step: 0.03 MHz
(c) Sampling rate: 1000/second

The loading loop measures |Γ| or |Γ|², varying coupler angle with the parameters:
(a) Max (initial) angle step: 5
(b) Min (turned) angle step: 0.5
(c) Sampling rate: 10/second

When the tuning system first turns on, everything is expected to be thoroughly de-tuned, so the step sizes are relatively large to approach the desired values quickly. Once the |Γ| falls below a certain threshold, then the step sizes will shrink. This idea is demonstrated through three main states: “tuning”, “re-tuning”, and “tuned”. While in the tuning state, the step sizes are large because the system is far from tuned. Below a certain |Γ| threshold, it enters the re-tuning state with smaller step sizes. Below an even lower |Γ| threshold, it enters the tuned state, where no step sizes are taken until |Γ| increases above that lower threshold. The control logic is summarized in FIG. 3. Using this method, after the system is tuned, it is expected to only enter the re-tuning state, with small adjustments to bring it back to tuned, instead of having to enter the tuning state. However, if there is some kind of sudden shift, then it will automatically enter the tuning state, with larger step sizes to quickly bring it back into the correct ballpark so that the re-tuning state can make fine adjustments.

The input impedance needs to be kept at 50Ω so that power can enter the helical resonator instead of being reflected back into the RF generator. To have a standard for the transmission cables, 50 or 75Ω can be used for impedance matching, and the current design prefers 50Ω to compromise between the maximum power and the lowest loss of typical coaxial cables. Most RF equipment is designed to match at 50Ω, and the equipment used in the present disclosure is designed for 50Ω. The sample impedance changes drastically with changing temperature, so the impedance controls must be constantly measuring and adjusting to maintain a 50Ω input impedance.

Impedance matching for RF sources include many choices depending upon the source and load. Capacitors, inductors, transformers, or combinations thereof can be used to match the real part of impedance. Each of these components can be variable to make it tunable. In the present design, a coupling antenna is used as a type of variable transformer and is preferred for the samples used in the examples. Alternative tunable impedance matching components may be used.

After cooling of a sample to the desired vitrified temperature, it is slid between the plates of the capacitor where it is rewarmed. In practice, the LN₂ spray is adjusted to provide the desired cooling rate and a hold period is generally added for the temperatures to equilibrate or stabilize before rewarming. In preliminary experiments, the capacitor plates are 7.5 cm in diameter and the plate spacing can be adjusted to accommodate either standard 3.5 ml (1 cm thick) polystyrene optical cuvettes or 10 ml (1.8 cm thick) custom cuvettes (sample holders). The latter are fabricated from RF rexolite crosslinked polystyrene with polystyrene microscope slide windows attached with cryogenic epoxy. An adjustable zoom macro lens and video camera system allows the entire process from cooling to warming to be recorded.

First tests were conducted with samples of pure CPA solutions to ensure the method succeeded in not forming crystals during devitrification. After many successful test runs to rewarm 3.5 and 10 ml samples of pure CPAs such as VS55, (that has critical warming rate of ^{˜}40° C./min), and DP6, (that has a critical warming rate of ^{˜}180° C./min), with no signs of crystallization, small cartilage samples were tested for successful rewarming. The initial viability assays had much greater viability than the control samples warmed by convection in a water bath. FIG. 20 summarizes the results of tests with 5 mm diameter×1.5 mm thick cartilage disk samples in 3.5 mL VS55. The top left shows viability in a fresh cartilage sample while the bottom left shows viability of a frozen cartilage samples. The fresh sample's cells are primarily alive, while the frozen cells are uniformly dead. In the middle, the effect of loading and unloading VS55 and loading/unloading VS83 (a higher concentration version of VS55) is compared. While the majority of the cells survive the VS55, the same loading/unloading protocol with VS83 causes widespread cell death at the surface of the cartilage (where exposure is longest due to slow diffusion of the CPA into the tissue). Careful, slow CPA diffusion for this RF method is necessary to properly rewarm viable tissues, cartilages, arteries, and organs-sufficient time must be given to diffuse the CPA into the cartilage to avoid drops in viability at the center of the samples. The diffusion may take 2-6 hours. The column on the right shows the effects of loading with CPA, vitrifying, and then unloading, comparing different vitrification methods. The top right shows convective warming with VS55, where warming is too slow at the center to prevent rewarming phase crystallization, leaving a hole of dead cells. The middle shows the effect of convective warming with VS83. The higher concentration CPA prevents rewarming phase crystallization, but the CPA toxicity leads to low cell viability at the tissue surface. Lastly, we have VS55 with the 2-parameter RF warming technology (present method) in the bottom right. The lower concentration CPA (VS55 instead of VS83) eliminates CPA toxicity while fast and uniform thawing leads to no rewarming phase crystallization.

Larger cartilage samples (10 mm×15 mm×2.5 mm in 7-10 ml of VS55) were successfully rewarmed using the present method. Compared against traditional convective thawing, the RF warmed large samples had much higher viability. The highest viability of any convectively warmed sample was ˜89%, whereas fully half of the RF warmed samples had a viability greater than 90%. The average viability versus average thickness for covectively warmed (n=6) vs RF warmed (n=12) large cartilage samples is shown in FIG. 21. The RF thawing method described herein is unambiguously superior to traditional convective heating.

The RF warming method successfully heats 10 mL samples without crystallization or overheating. Heating uniformity is a significant challenge for larger samples and can lead to rewarming phase crystallization and thermal gradients. FIG. 19 shows the temperature gradients during rewarming of VS55 at a heating rate of approximately 60° C./min (the critical warming rate of VS55 is typically estimated to be about 40° C./min) (Channels 1-3 probe the 10 mL cuvette at different locations, channel 4 in the air). The temperature gradients during rewarming VS55 are extremely small, showing that large samples can be heated uniformly and fast with the RF warming system and method.

The overall approach to rewarming is demonstrated by results of rewarming cartilage, where a complete vitrification and dielectric rewarming system has been developed that shows successful rewarming of small cartridge samples. To uniformly rewarm larger samples, the apparatus may be modified to increase the sample volume and to improve its rewarming uniformity. The RF approach to rewarming can be used to avoid crystallization and cracking during rewarming of frozen tissues, organs, cartilage, and the like and results in viable tissues, organs, cartilage, etc. after thawing.

During testing, polystyrene cuvettes were filled with 3.4 ml of a cryoprotectant cocktail, preferably DP6 or VS55. One fiber optic temperature sensor in the cuvette measures temperature, and another one in the chamber measures the ambient cryogenic chamber temperature. The cuvette starts in the forward position (between the electrode plates) with the RF system turned off. LN₂ is flowed into the chamber to pre-cool it. As the chamber approaches −100° C., the sample is typically around 0° C. (the melting temperature of DP6 is −35° C.). At this point, the DP6 cuvette is moved back between the LN₂ sprayers to quickly cool it (−30° C./min to −40° C./min), suppressing crystallization and promoting vitrification.

An imaging system watches the CPA in situ, to look for signs of crystallization or cracking. In the forward position between the electrode plates, the imaging system uses back lighting, and while it is in the back position, between the LN₂ sprayers, the imaging system illuminates the front of the cuvette. During cooling, there were no signs of crystallization or cracking during any tests. With back lighting, crystals are easy to observe as dark spots (or totally blacked out domain in the case of full crystallization).

Once the sample reaches approximately −100° C., it is moved back to the forward position (between the electrode plates). The RF warming system is turned on, and the sample is heated as quickly as possible until approximately 0° C. Temperature is recorded throughout the re-warming process.

Regarding CPAs, the most preferred are mixtures of small molecule solvents with high dipole moments and the ability to hydrogen bond to water. They are referred to in CPA literature as penetrating solvents that go through cell membranes. The main components are dimethyl sulfoxide (DMSO), polypropylene glycol (PG), ethylene glycol (EG), formamide (FMD), glycerol (GLY), and butanediol (BD), but others can be added. Mixtures of these components have less toxicity than a high concentration of a single component, and therefore it is preferred to use CPA mixtures of these.

Many CPAs may be used to achieve uniform, volumetric warming with the present method. These CPAs include, but are not limited to: DMSO; FMD; PG; CPA cocktails containing DMSO, FMD, and PG in different amounts and overall concentrations (e.g., DP6, DP7, DP8, VS55, VS83); CPA cocktails containing DMSO, FMD, PG, and optional additional components (e.g., M22). Any CPA made of large polar molecules will work with the present method, including CPAs made from sugar solutions (e.g., sucrose or trehalose). Good results are maintained for CPA solutions that successfully vitrify and that have a peak in the imaginary part (e″) of the dielectric constant that is below approximately −30° C. at frequencies between 10-100 MHz. I.e., the maximum power adsorption given by the dielectric relaxation frequency remains below −30° C. at heating frequencies of 30-50 MHz.

Using highly concentrated CPA like M22, the critical cooling and warming rates needed to prevent vitrification are very slow, so volumetric rewarming is less important. Most tests described herein use DP6 and VS55 to avoid problems with toxicity. DP6 and VS55 are less concentrated (less problems with toxicity), so fast uniform heating is necessary to scale them up to large tissues and full-size organs. The preferred CPA may vary with the sample size and type. In general, cartilage, tissue, and organ viability results are better using the RF warming approach described herein (regardless of using DP6, DP8, VS55, VS83, other CPAs) than thawing via warm water bath or other convective warming methods.

The DPx series is mixtures of equal amounts DMSO and PG ranging in concentration (DMSO+PG) from 6 Molar to 8 Molar in a biocompatible carrier solution that is mainly water and some ions for maintaining osmolality. Tests described herein use both the low DP6 and the high DP8 concentrations, demonstrating that any molarities in between will also work. Similarly, the VSxx series is a mixture of DMS, FMD, and PG in the biocompatible carrier. For VS55, the mixture is added to the carries such that is it 550 g/L. For VS70, it is added to 700 g/L, and for VS83, it is added to 830 g/L. All these concentrations have been demonstrated herein, and thus any concentrations in between will also work. For better tissue compatibility, PG is sometimes replaced by EG.

Additional improvements to the presented software and control scheme may include: speeding up the control loop, adding extra data streams, improving power control, maintaining a constant delivered power, improving impedance matching control (the slow loop) and adjusting the electrode shape to generate more uniform electric field inside of the sample. Additional improvements to the rewarming may also include: modifying the CPA solution, modifying the perfusion time, modifying the sample, modifying the orientation of the sample. With these improvements, the method may be successful for rewarming even larger tissues (cartilage, arteries, organs, skin patches, etc.), and larger volumes of CPAS. The success of the present method demonstrates the feasibility of these rewarming challenges by adjusting the method to different sized and shaped samples.

The present approach uses low frequency RF waves, which have long wavelengths capable of achieving large penetration depth and uniform heating. The present approach provides good thermal stability, which improves heating uniformity compared to methods in the art (minimizes thermal runaway). The present method is capable of producing extremely fast heating without inducing mechanical stress. The method only requires CPAs (no nanoparticles), so there is no concern with nanoparticle loading or unloading (it is very challenging to load nanoparticles into avascular tissue such as cartilage). The 2-parameter RF warming approach volumetrically heats samples (tissue, cartilage, organ, etc.) quickly and prevents rewarming crystallization.

### CPA Example: DP6

The most critical time to achieve fast warming is roughly −80° C. to −35° C. for DP6. At very low temperatures, fast warming is less critical because high viscosity slows down crystallization, and at warmer temperatures, DP6 is above its melting temperature, Tₘ, and won't crystallize at all. The disclosed warming system is effective at warming at temperatures above −90° C.

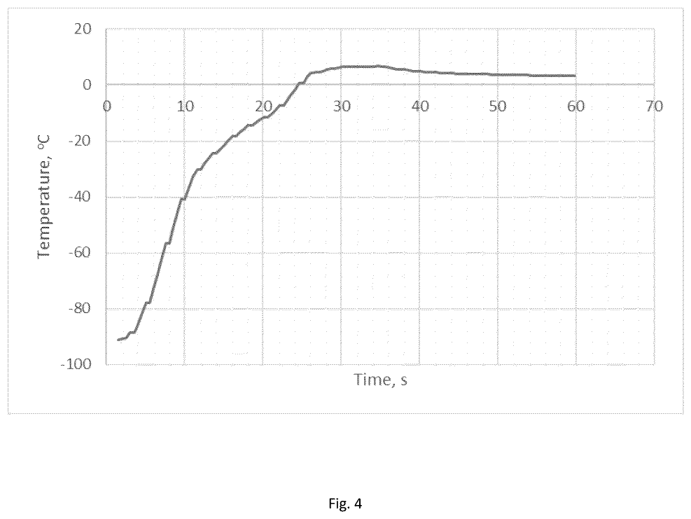

FIG. 4 shows a typical temperature vs time graph for samples of DP6 rewarmed using the disclosed 2-parameter controlled RF warming system. The heating is extremely rapid for ^{˜}26 seconds, at which point the power to the RF system was shut off to prevent overheating the sample. There is some slow carry over warming until about t=32 seconds, and then slow cooling is observed (since it is sitting in a cold cryogenic chamber between cold electrodes).

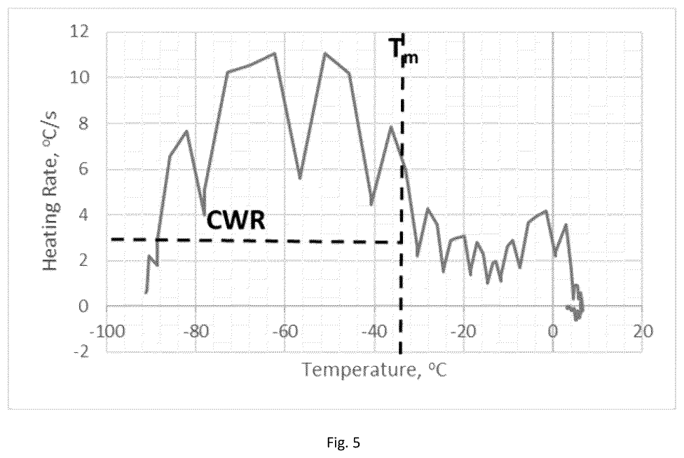

The average warming is well above the critical warming rate (CWR) for DP6, 3.15° C./s. The DP6 sample warmed from −90.5° C. to −30.3° C. in 9.05 s for an average warming rate of 6.65° C./s. The instantaneous heating rate was calculated using a centered finite difference approximation of the derivative of the temperature with respect to time. The heating rate as a function of the sample temperature is shown in FIG. 5 with the melting temperature Tₘ of DP6 indicated by the vertical dashed black line and the CWR indicated by the horizontal black line. As shown in FIG. 5, a maximum heating rate may go up to ^{˜}11° C./s for a short period, and importantly, stays at or above the critical warming rate for the entire critical region below Tₘ. Based on these heating curves, the sample should not have suffered from any rewarming phase crystallization.

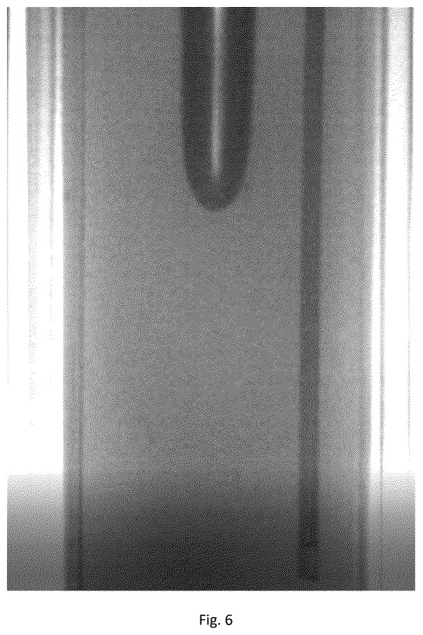

Lack of crystallization was verified by imaging the sample in situ. FIG. 6 shows the sample at the start of warming. One can see through the sample in its forward position during all stages of cooling and rewarming, clearly indicating that there was no crystallization. The fiber optic temperature sensor is clearly visible to the right of each image, and the dip in the surface of the DP6 (visible at the top) only occurs when the sample vitrifies, not when it crystallizes. There were no signs of cracks and no signs of crystals, and these results are repeatable. Overall, the disclosed system can heat samples extremely rapidly (always above the CWR for DP6) without any signs of cracks or crystals.

### CPA Example: DP8

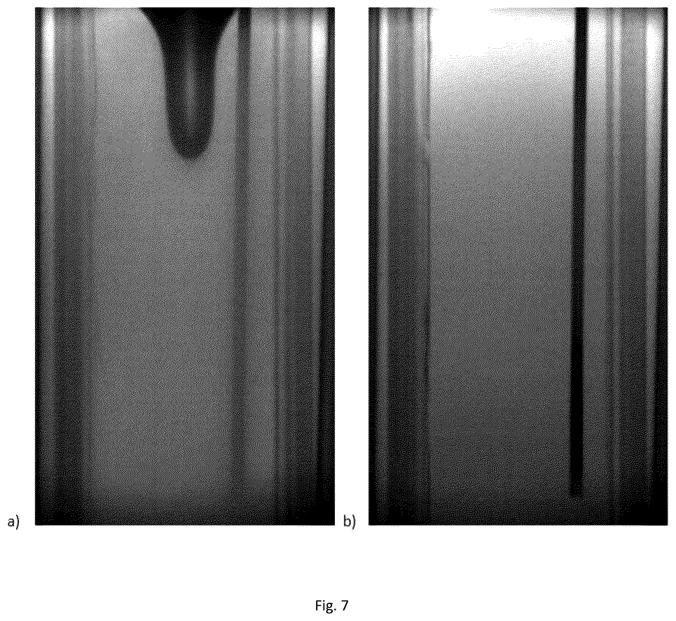

No crystallization is visible during warming tests with DP8. The estimated CWR is at or below 0.23° C./s, and the heating rate stayed at or above this value throughout the duration of the test. FIG. 7 shows imaging of a DP8 sample in situ, showing no cracks or ice crystals in the left vitrified sample image, or the right successfully rewarmed image.

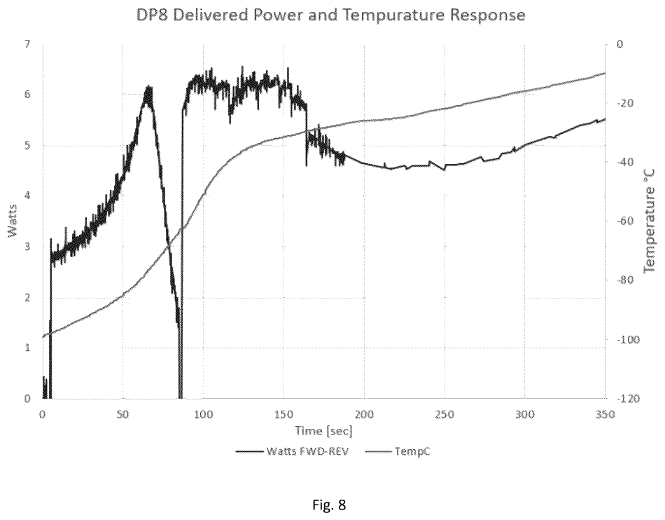

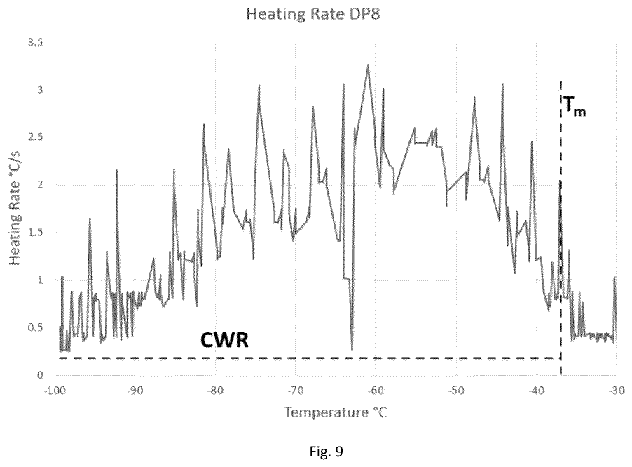

FIG. 8 shows the power delivered to a 3.5 ml sample of DP8 during a lower power run. Heating occurs slowly over 300 seconds with no visible crystallization. A loss of heating occurred briefly around 89 seconds due to a program bug that was corrected after testing. FIG. 9 shows the warming rate vs temperature for the same heating test of DP8, and the warming rate remains above the CWR for the entirety of the test.

### CPA Example: VS55

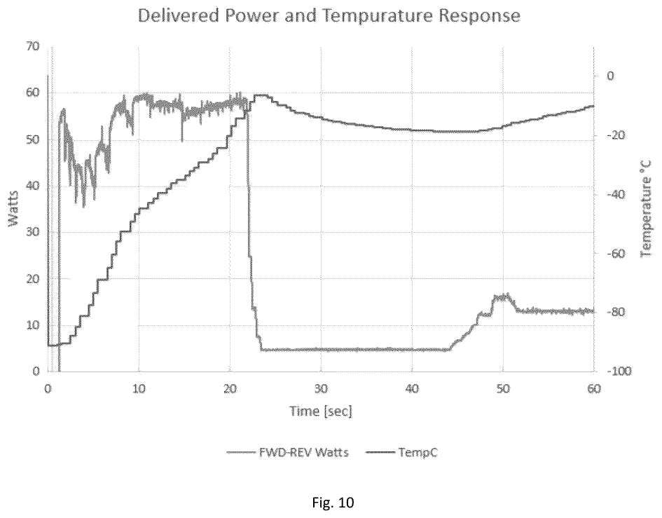

FIG. 10 shows the typical temperature vs time graph for samples of VS55 rewarmed using the disclosed 2-parameter controlled RF warming system. Similar to DP6, the VS55 was rapidly heated for ^{˜}24 seconds before the generator power was reduced to prevent overheating. The sample cooled slowly between 25 and 45 seconds until the generator was increased slightly to compensate and prevent crystallization. FIG. 10 also shows delivered power measured (forward power-reverse power) with the temperature sensor data overlaid. Delivered power averaged 54.34 watts over the duration of the VS55 heating test.

The average warming is well above the CWR for VS55, 0.92° C./s. The VS55 sample warmed from −91.2° C. to −35.1° C. in 14 seconds for an average heating rate of 4.1° C./s. The heating rate as a function of sample temperature is shown in FIG. 11 with the melting temperature Tₘ of VS55 indicated by the vertical dashed black line and the CWR indicated by the horizontal black line. As shown in FIG. 11, a maximum heating rate of ^{˜}9° C. was observed, and stays at or above the critical warming rate for the entire critical region below Tₘ. Based on these heating curves, the sample should not have suffered from any rewarming phase crystallization.

Based on the average heating rate of 4.1° C./s and the average delivered power of 54.34 watts, and assuming the same specific heat at DP6 results in an average ^{˜}36.1 W heating. Some of power loss on the order of 4 W can be explained by overcoming the cooling rate of the chamber and electrodes. This yields a stray power loss of 14 W or 25.8%.

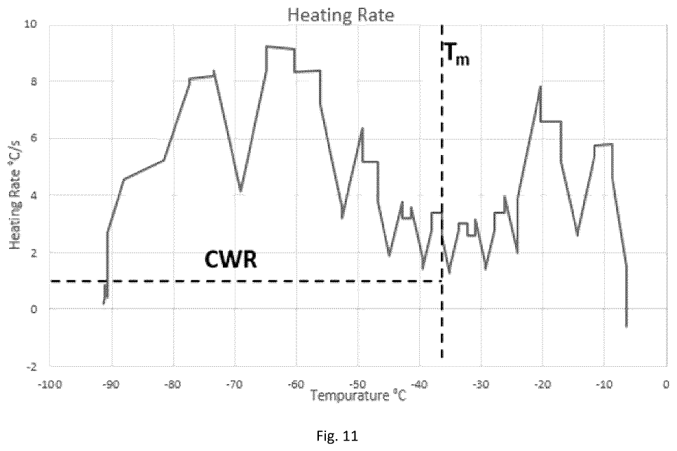

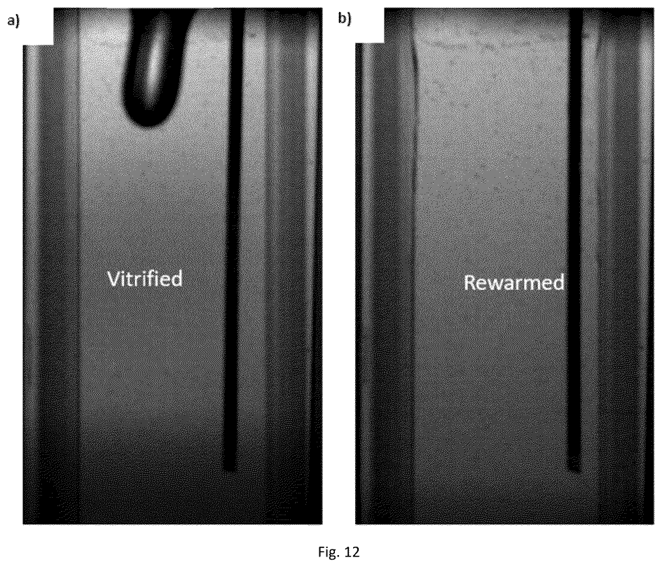

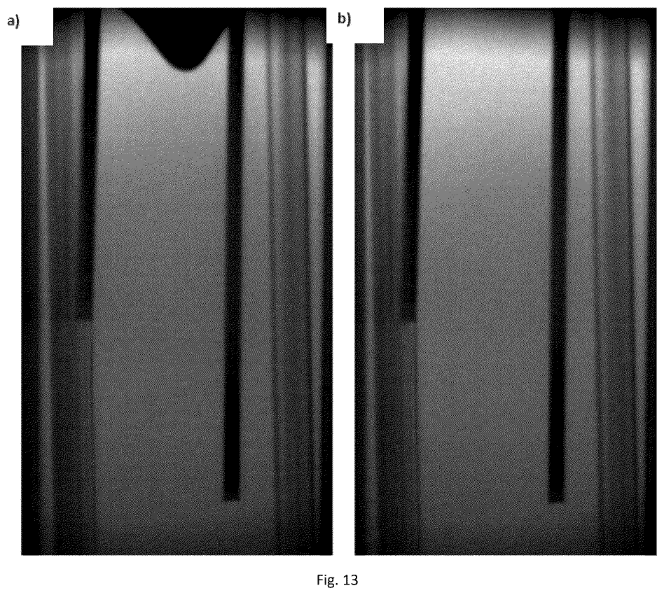

Lack of crystallization was verified by imaging the VS55 sample in situ, shown in FIG. 12. One can see through the sample in its forward position during all stages of cooling and rewarming, clearly indicating that there was no crystallization during cooling. The fiber optic temperature sensor is clearly visible to the right of each image, and the dip in the surface of the VS55 (visible in top left) only occurs when it vitrifies, not when it crystallizes.

### CPA Example: VS83

No crystallization occurred during any rewarming test using VS83. Lack of crystallization was verified by imaging the VS83 sample in situ, shown in FIG. 13. One can see through the sample in its forward position during all stages of cooling and rewarming, clearly indicating that there was no crystallization during cooling. Multiple optical temperature sensors are visible and were used to identify any temperature gradients and ensure heating uniformity.

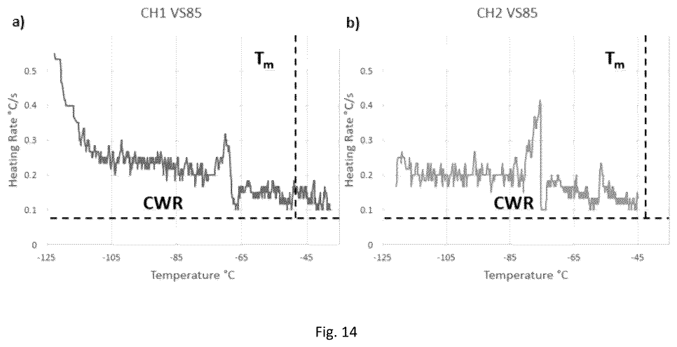

FIG. 14 shows the slowest tested heating rate vs temperature on each of the two temperature sensors. The rate of warming measured on both sensors was at or above the CWR of VS83, 0.1° C./s. A maximum heating rate of 0.75° C./s was observed during this heating test. The average delivered power was at or below 1W for the duration of this warming run. No crystallization was observed during the 7-minute heating duration.

### RF Rewarming of Cartilage

The present RF warming system provides successful rewarming for small, medium, and large scale samples of cartilage. This success suggests that the 2-parameter RF warming system is a viable option for rewarming larger organs, limbs, tissues, cartilages, arteries, skin patches, etc.

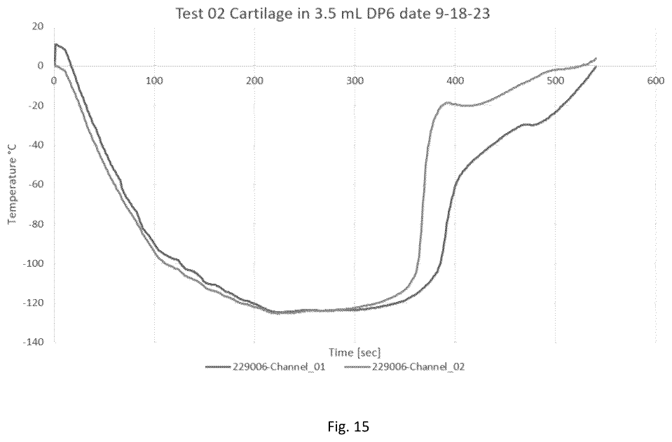

Small articular cartilage samples fit into the 3.5 mL cuvettes used in preliminary CPA tests. FIG. 15 shows the temperature plot of a 3.5 ml sample of PD6 with porcine cartilage subjected to 16 W of RF warming. Photographs in situ confirmed that there was no visible rewarming phase crystallization.

Scaling up to larger cartilage samples, 10 mL cuvette with DP6 were used to fit the samples. To prop the cartilage sample up to where it can be seen in the cryogenic chamber, PTFE blocks were placed at the bottom of the cuvette. Four temperature probes were placed into the cuvette at different locations.

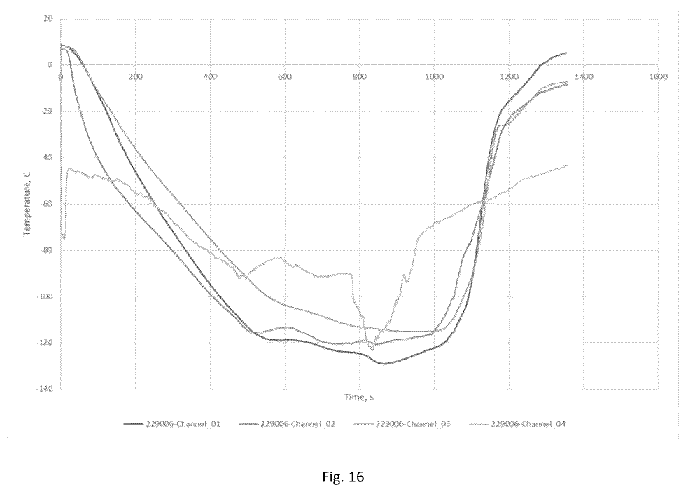

Using VS55 provides the advantage that it is more concentrated, so has a lower critical warming rate than DP6. Thus, the heating rate can be turned down without causing crystallization to achieve more uniform warming. The critical warming rate of VS55 is estimated to be about 40° C./min, and during initial rewarming experiments, approximately 60° C./min was the target rate of rewarming. As seen in FIG. 16, the temperature gradients during rewarming (Channels 1-3, with channel 4 in the air) were extremely small. This represents proof of concept that larger samples can be heated with uniformly fast warming using our RF warming system.

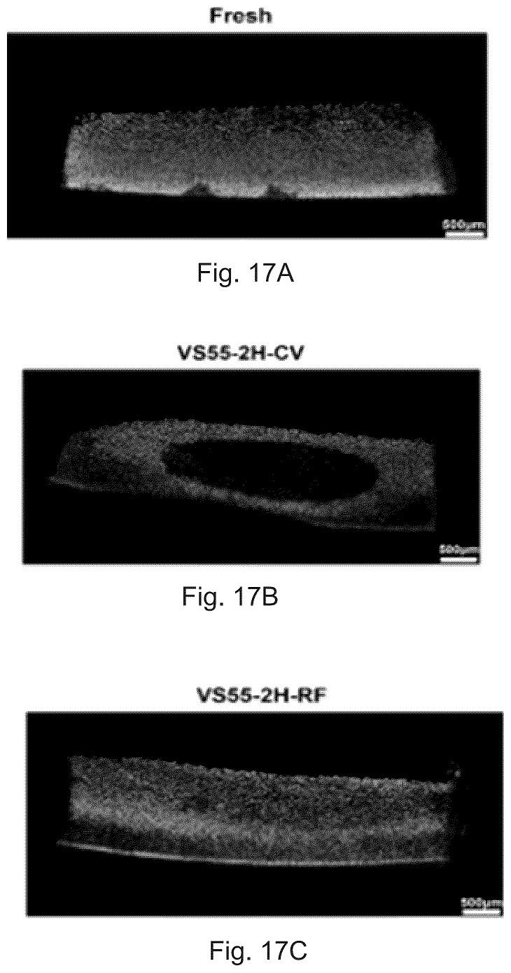

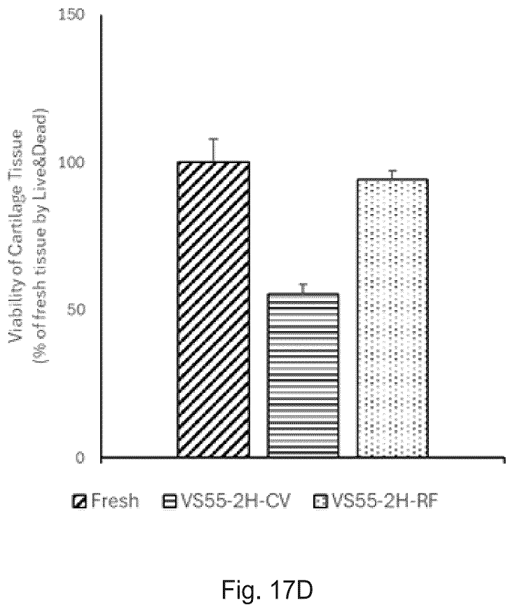

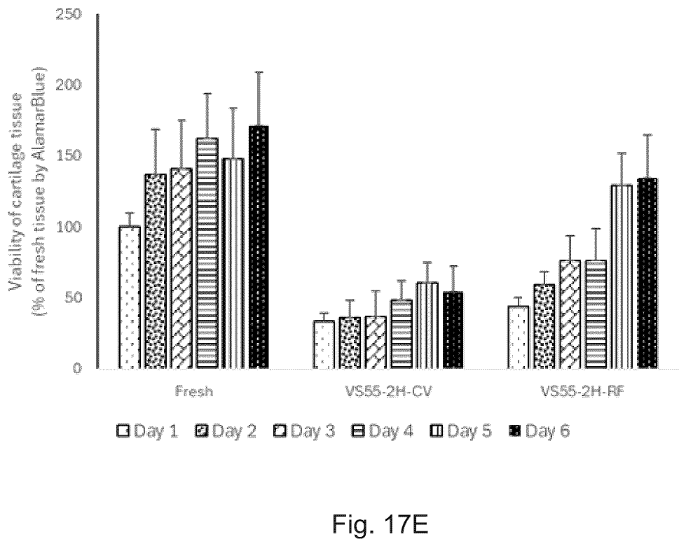

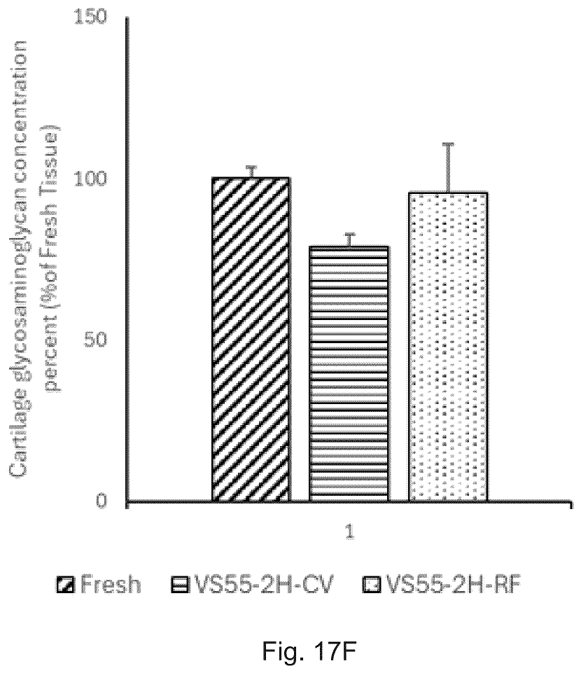

The 2-parameter RF rewarming method not only prevents crystallization, but also produces viable tissue post-rewarming. Articular cartilage was perfused with VS55 and then rewarmed using the RF system and showed very high viability throughout the volume of the cartilage. Results are shown in FIGS. 17A-C, where the RF-rewarmed cartilage (VS55-2H-RF) is compared to a cartilage sample perfused with VS55 identically to the RF sample but rewarmed convectively (VS55-2H-CV) and a fresh sample of cartilage. Fluorescence live/dead imaging showed survival of 94.2%+2.8% for the RF warmed samples and only 55.3%+3.5% for the convectively warmed samples, as shown in FIG. 17D. Moreover, a 100% recovery in metabolic activity of tissues in RF groups was observed after 4-day incubation post rewarming, whereas conventionally rewarmed tissues exhibited only an approximately 60% recovery in cellular metabolic function, shown in FIG. 17E. Lastly, the RF warming also preserved the cartilage's glycosaminoglycan (GAG) as shown in FIG. 17F, which is an important part of the physiology of the cartilage.

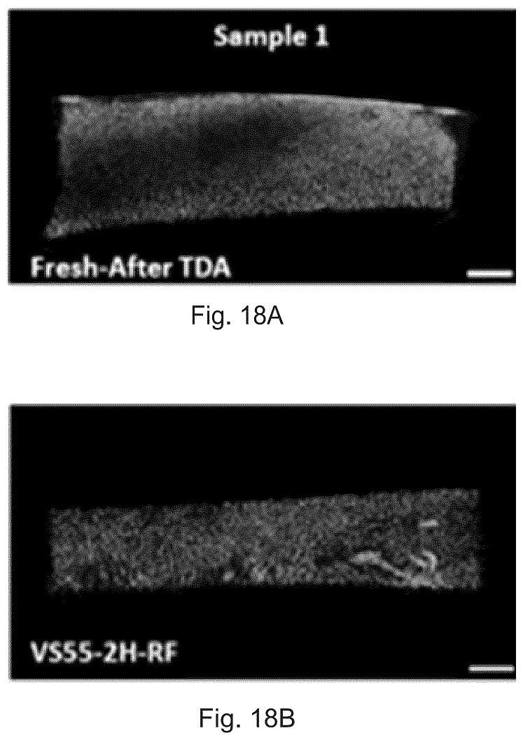

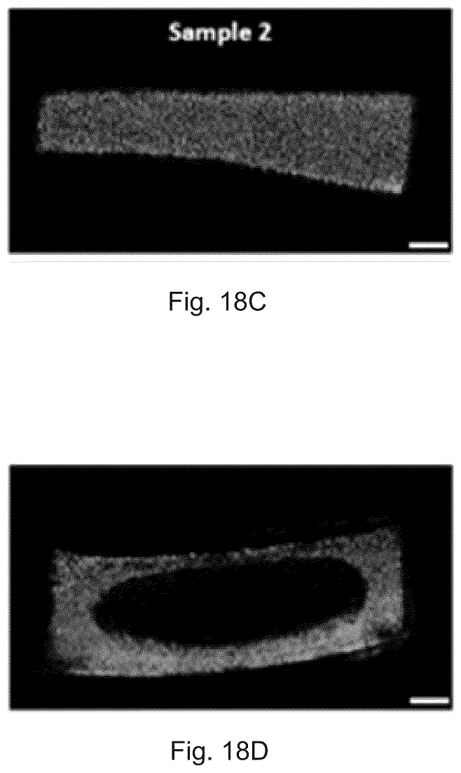

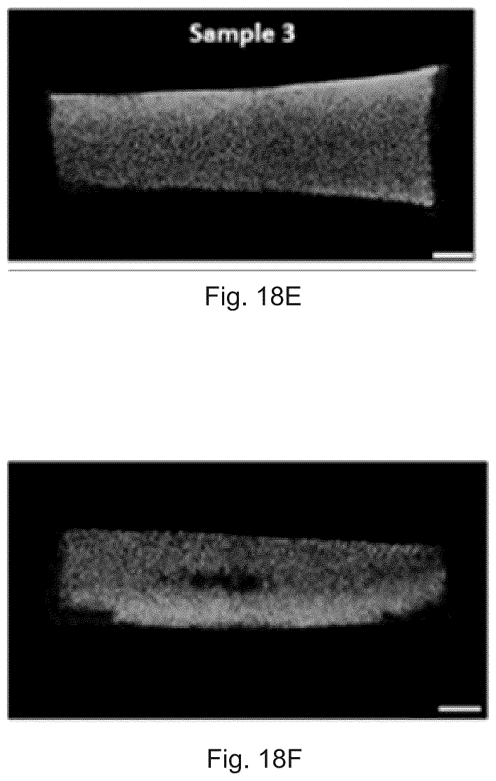

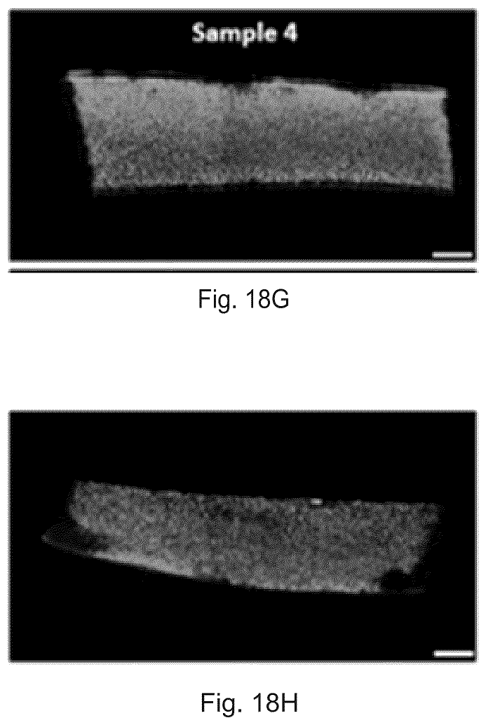

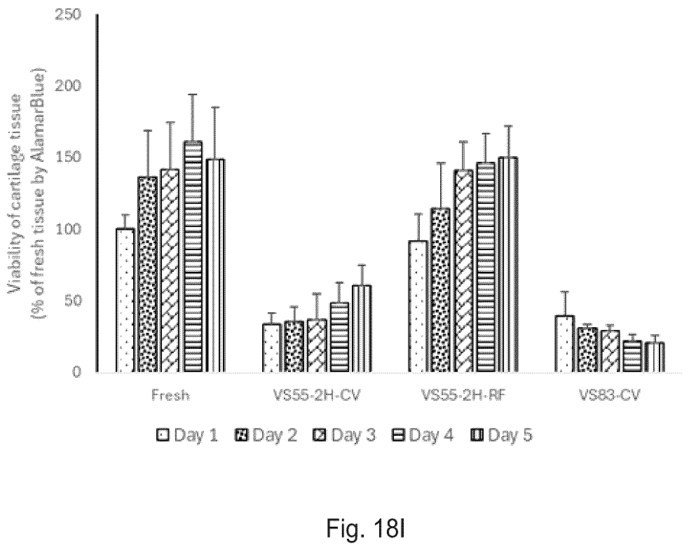

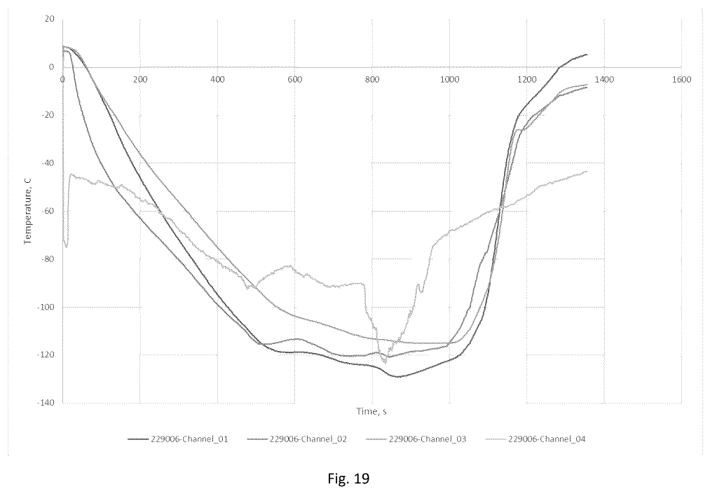

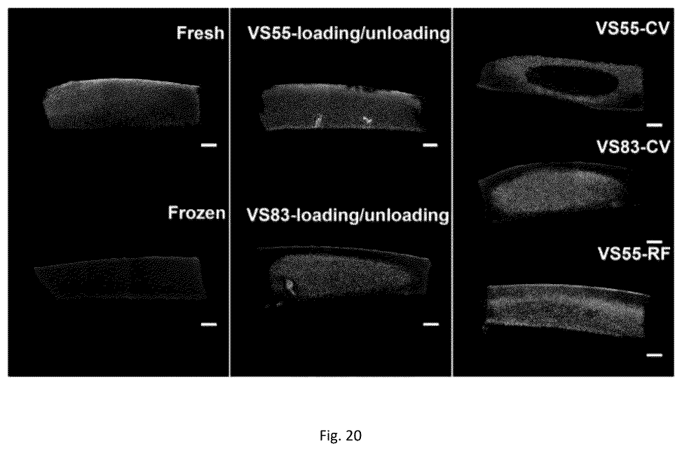

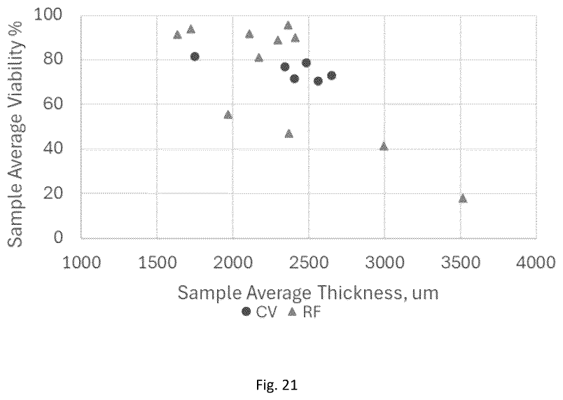

Another round of tissue testing for VS55 used higher warming rates. The results are shown in FIGS. 18A-H. Sample 1 is shown in FIGS. 18A-B, sample 2 is shown in FIGS. 18C-D, sample 3 is shown in FIGS. 18E-F, and sample 4 is shown in FIGS. 18G-H. FIGS. 18A, 18C, 18E, and 18G show fresh-after TDA tissue, and FIGS. 18B, 18D, 18F, and 18H respectfully, show the associated samples in VS55. Three samples showed very high viability and are seen in FIGS. 18A-B, 18D-F, and 18G-H. The alamarBlue® test results in FIG. 181 show that the vitrified/RF rewarmed cartilage samples (VS55-2H-RF) recovered to 100% of fresh tissue within 2 days while the vitrified/convectively rewarmed sample (VS55-2H-CV) recovered to a max of 70% after 5 days, and the vitrified/convectively warmed sample (VS83-2H-CV) recovered to a max of 50% on day 1 and with recovery reducing each consecutive day. AlamarBlue® is a cell proliferation assay reagent designed to quantitatively measure the proliferation of various human and animal cell lines, bacteria and fungi. It is an indicator dye, that incorporates an oxidation-reduction (REDOX) indicator that both fluoresces and changes color in response to the chemical reduction of growth medium, resulting from cell growth. Continued growth maintains a reduced environment (fluorescent, red), and inhibition of growth maintains an oxidized environment (non-fluorescent, blue).

What is claimed is:

1. A method for rewarming vitrified tissues, the steps comprising:
a) providing a RF warming apparatus;
b) providing a vitrified tissue, wherein the vitrified tissue is perfused with a CPA;
c) continuously adjusting an input frequency to maintain a resonant frequency throughout the RF warming apparatus;
d) continuously tuning an impedance matching source to maintain a system impedance of 50Ω-75Ω; and,
e) uniformly warming the vitrified tissue at a rate above the critical warming rate for the CPA between −80° C. and −30° C.

2. The method as in claim 1, wherein the CPA has a maximum power adsorption below −30° C. at frequencies of 10-100 MHz.

3. The method as in claim 1, wherein the input frequency is 10-100 MHZ.

4. The method as in claim 3, wherein the input frequency is 30-50 MHZ.

5. The method as in claim 1, wherein continuously adjusting the input frequency comprises:
aa) measuring a reflected power;
bb) adjusting the input frequency to a higher frequency, then re-measuring the reflected power;
cc) adjusting the input frequency to a lower frequency, then re-measuring the reflected power;
dd) comparing the reflected power of the higher frequency and the reflected power of the lower frequency to select a new input frequency; and,
ee) repeating steps aa)-dd).

6. The method as in claim 1, wherein continuously adjusting the impedance matching source comprises:
aaa) measuring a reflected power;
bbb) adjusting the impedance matching source to a new position in a first direction, then re-measuring the reflected power;
ccc) adjusting the impedance matching source to a new position in a second direction, then re-measuring the reflected power;
ddd) comparing the reflected power of the new position in the first direction and the new position in the second direction to select a new position; and,
eee) repeating steps aaa)-ddd).

7. The method as in claim 1, wherein the impedance matching source is a coupling antenna or a variable capacitor.

8. The method as in claim 1, further comprising:
f) retrieving a thawed tissue, wherein at least 70% of the thawed tissue is viable.

9. The method as in claim 1, wherein the input frequency is 40 MHz.

10. The method as in claim 1, wherein the CPA is DP6, DP8, VS55, or VS83.

11. The method as in claim 10, wherein the CPA is DP6 or VS55.

12. The method as in claim 1, wherein warming the vitrified tissue does not comprise forming crystals, cracks, or thermal gradients in the vitrified tissue.

13. The method as in claim 1, wherein the system impedance is 50 Ω.

14. The method as in claim 1, wherein continuously adjusting the input frequency further comprises adjusting the input frequency at least 100 times per second, and wherein continuously tuning the impedance matching source comprises tuning the impedance matching source at least 10 times per second.

15. The method as in claim 14, wherein continuously adjusting the input frequency further comprises adjusting the input frequency 500-1000 times per second, and wherein continuously tuning the impedance matching source comprises tuning the impedance matching source 50-100 times per second.

16. A method for impedance matching during RF rewarming, the method comprising:
a) measuring a frequency, a reflected power, and a reflected voltage;
b) adjusting the frequency to maintain a resonant frequency at least 100 times per second, the steps comprising:
i) measuring a reflected power;
ii) adjusting the input frequency to a higher frequency, then re-measuring the reflected power;
iii) adjusting the input frequency to a lower frequency, then re-measuring the reflected power;
iv) comparing the reflected power of the higher frequency and the reflected power of the lower frequency to select a new input frequency; and,
v) repeating steps i-iv; and,
c) tuning an impedance coupler at least 10 times per second to maintain a system impedance of 50Ω-75Ω, the steps comprising:
i) measuring a reflected power;
ii) adjusting the impedance matching source to a new position in a first direction, then re-measuring the reflected power;
iii) adjusting the impedance matching source to a new position in a second direction, then re-measuring the reflected power;
iv) comparing the reflected power of the new position in the first direction and the new position in the second direction to select a new position; and,
v) repeating steps i-iv.

17. The method as in claim 16, further comprising the step:
d) reheating a sample without forming any crystals or cracks.

18. The method as in claim 16, wherein the impedance coupler is a coupling antenna or a variable capacitor.

19. The method as in claim 16, wherein the impedance remains matched from −80° C. to −30° C.
